(19) United States
(12) Patent Application Publication
(10) Pub. No.: US 2012/0002409 A1
(43) Pub. Date: Jan. 5, 2012

(54) CARRIER COMPRISING AT LEAST ONE SEMICONDUCTOR LUMINOUS DEVICE AND CARRIER SYSTEM

(75) Inventor: Thomas Donauer, Kelheim (DE)

(73) Assignee: OSRAM AG, Muenchen (DE)

(21) Appl. No.: 13/256,230

(22) PCT Filed: Mar. 15, 2010
(86) PCT No.: PCT/EP2010/053261

§ 371 Date: Sep. 13, 2011

(30) Foreign Application Priority Data
Mar. 24, 2009 (DE) 10 2009 014 536.2

(51) Int. Cl. F21V 21/00; F21V 29/00; F21V 11/00

(52) U.S. Cl. 362/218; 362/217.16; 362/217.02

(57) ABSTRACT

In various embodiments, a mount may include an elongated basic form which is configured to include at least two functionalities, of which at least one functionality is a lighting functionality, wherein to implement the at least one lighting functionality, the mount includes at least one semiconductor lighting device.

The invention relates to a mount having a least one semiconductor lighting device, in particular an LED strip, and a mounting system comprising such a mount.

Virtually endless, flexible LED strips are known that are fitted with light emitting diodes on their front face and which can be affixed on their rear face, for instance using a dual-sided adhesive tape. The front face can also contain other electronic components and contacts for making electrical contact with external devices such as a power supply, etc. The light emitting diodes, the electronic components that may be present and the contacts are connected together via a front-face wiring layer including conductor tracks and contact pads. Polyamide in strip form can be used, for example, as the flexible substrate. LED strips of this type are known, for example, from the LINEARLight series from the Osram GmbH company. An LED strip from the LINEARLight series can also be constructed contiguously from standard elements, between which it is possible to divide up the LED strip in order to form correspondingly shorter LED modules. The LED strips can be connected together and to a power supply electrically and mechanically by means of proprietary connectors e.g. from the CONNECT system series from the Osram GmbH company.

Mounts in the form of mounting rails for fastening drapes are known. These can be fitted by means of a right-angled wall bracket.

LED wallwashers are also known, in which light emitting diodes are arranged in a mount in the form of a batten, and the batten can be fixed by means of a wall bracket.

The object of the present invention is to provide a mount having an improved range of functions.

This object is achieved according to the features of the independent claims. The preferred embodiments appear in particular in the dependent claims.

The object is achieved by means of a mount having an elongated basic form and which is designed to include at least two functionalities. Of the at least two functionalities, at least one functionality is a lighting functionality. To implement the at least one lighting functionality, the mount includes at least one semiconductor lighting device, in particular an LED lighting device.

An elongated basic form is understood to mean a shape having a long side, the dimension of which is substantially greater than perpendicular thereto, in particular at least twice as great, preferably more than ten times as great, wherein the dimension perpendicular to the long side does not need to be the same throughout the length of the long side.

By virtue of its lighting functionality, the mount can be considered in particular to be a luminaire, which includes a semiconductor device and at least one other functionality.

This multipurpose mount has the advantage that it is more versatile than previously known single-purpose mounts.

The at least one semiconductor lighting device can include at least one semiconductor light source. The semiconductor light source can include, for example, at least one diode laser or at least one light emitting diode. The light emitting diode can emit monochromatic or polychromatic e.g. white light. When there are a plurality of light emitting diodes, these can e.g. provide light in the same color (monochromatic or polychromatic) and/or in different colors. For instance an LED module may include a plurality of LED chips (an LED cluster) which together can produce a white mixed light, e.g. in ‘cool white’ or ‘warm white’. To produce a white mixed light, the LED cluster preferably includes LED chips that provide light in the primary colors red (R), green (G) and blue (B) (RGB LED cluster). In this case, single or multiple colors can also be produced simultaneously by a plurality of LEDs; for instance combinations RGB, RRGB, RGGB, RGBB, RGGBB, etc. are possible. The color combination is not limited to R, G and B, however. To produce a warm-white hue, one or more amber LEDs (A) and/or white LEDs (W) can be present, for example. Where LEDs have different colors, they can also be controlled so that the LED module radiates in a tunable RGB color region. To produce a white light from a mixture of blue light with yellow light, it is also possible to use LED chips equipped with fluorescent material, e.g. in surface mount technology, e.g. in “chip-level conversion technology”. Other methods can also be used, such as a red/green combination using conversion technology. Of course a “traditional” conversion that is not performed on-chip is also possible. An LED module can also comprise a plurality of white single chips, thereby providing a simple means of scaling the luminous flux. The single LEDs and/or the modules can be equipped with suitable optical components for beam guidance, for instance Fresnel lenses, collimators and so on. Instead of, or in addition to, inorganic light emitting diodes, e.g. based on InGaN or AlINGaP, organic LEDs (OLEDs) can also be used in general.

It can be an advantageous embodiment when one of the at least two functionalities is a fastening function for at least one view screening element, e.g. drape, curtain, awning or blind. The mount can then be configured both as a luminaire and as a fastening for a view screen, in particular as a curtain rod or curtain rail. In this case, the long length of the mount for implementing the fastening function is suitable in particular for use with a large-area lighting device, e.g. with an LED wallwasher.

It can be advantageous if the mount has at least one mounting surface for the at least one lighting device, wherein a protruding wall is present at least on one side of the mounting surface. This can prevent a viewer being dazzled, and it can make it harder to touch the lighting device.

It can also be advantageous if the mount includes a mounting rail. An item of this type is particularly easy to fabricate, even with complex-shaped rail cross-sections.

To separate at least two functionalities spatially, it can be advantageous if at least these two functionalities are implemented on opposite surfaces, e.g. on a top side and on a bottom side of the mount or a part of the mount, such as a plate having a mounting surface.

For the spatial separation and for screening the functionalities from external view (e.g. in order to prevent dazzle) and/or to prevent direct access (e.g. touching the lighting device), the mounting rail can advantageously have a substantially H-shaped or recumbent T-shaped cross-section.

In particular, the vertical sections (arms) of the “H” or the recumbent “T” can be used for screening, while the horizontal section (cross-link) of the “H” or the recumbent “T” is used at least for mounting the semiconductor lighting device. A view screening element can then be mounted in particular on the side facing away from the semiconductor lighting device.

In order to provide a variety of lighting effects, it can be advantageous if the mount has at least two lighting functionalities, and at least one respective semiconductor lighting device is present for each of the lighting functionalities. For instance, one semiconductor lighting device of a first lighting functionality can have semiconductor light sources that have a white emission in order to provide room illumination, while a semiconductor lighting device of a second lighting functionality can have semiconductor light sources that radiate colored light in order to create a color effect. These lighting functionalities can be arranged on the same side of the mount e.g. side by side, or on different sides.

The cross-section of the mounting rail can have straight regions and/or curved regions, specifically also in the “H” shape or in the recumbent “T” shape. For instance, the arms of the “H” may be shaped so that they are straight, in some sections oval and/or in some sections circular.

In order to fit the lighting device easily, it can be advantageous if at least one of the semiconductor lighting devices has a lighting strip, in particular an LED strip. The lighting strip can be rigid or flexible.

A mount having at least two lighting functionalities can advantageously have at least one lighting strip per lighting functionality in order to provide a variety of lighting effects, the at least one lighting strip of one of the lighting functionalities having a different emission characteristic from the at least one lighting strip of the other lighting functionality. The different emission characteristic may include, for example, a different color, a different uniformity, a different beam angle and/or a different luminous intensity.

To adjust an emission characteristic, at least one lighting strip can advantageously be covered at least partially by an optical element. This cover may include e.g. at least one lens, one diffuser, one reflector (with or without pivot facility), one color screen and/or one aperture. The emission characteristic can also include spreading or focusing the emitted light.

In order to cool in particular the at least one lighting device simply and effectively, the mount can advantageously be designed as a heat sink for at least the at least one lighting functionality. For this purpose, the mount can be made, for example, of a material that has a good thermal conductivity (λ>15 W/(m·K), e.g. aluminum or steel, can include at least one heat removal means to assist heat dissipation in particular by means of convection (e.g. cooling fins, cooling pins, cooling slots, etc.) and/or can be equipped with a fan.

Especially for an application as a wallwasher, it can be advantageous if the mount has a fixing element, in particular a stand-off bracket, for fixing the mount, in particular its mounting rail. A stand-off bracket can be, for example, a right-angled or straight wall bracket or fixing hook.

Simple adjustment of a size of an illumination area can be assisted by the stand-off bracket being advantageously designed for variable adjustment of the stand-off distance. The stand-off bracket can have for this purpose a slot, for example.

An electrical connection to the at least one lighting device located on the mount, in particular on the mounting rail, can be implemented, for example, by means of a connection via cables that are fed out of the mounting rails. In this case a cable can optionally be fastened to one or more fixing elements.

Alternatively, at least one fixing element, in particular a stand-off bracket, can itself act as a contact if it is an electrical conductor. Provided the lighting device is operated in the low-voltage region (e.g. ≦24 VDC), there is no need to worry about touching posing a health risk to a person. A particularly space-saving embodiment having a high-quality design can hence advantageously be achieved by the fixing element being designed for electrically connecting at least the at least one semiconductor lighting device.

Where electricity is conducted from the wall to the module, a functional unit can optionally be used for the conduction of electricity, for example through built-in cables. Thus, in order to need to draw just one set of electrically conducting connecting elements (e.g. cables) from e.g. the wall or the ceiling to the mounts for a combination (e.g. a series) of a plurality of lighting device, a functional unit can be fitted with electrically conducting elements (cables, printed circuit boards, etc.) in order to supply the linked modules sequentially. Alternatively, a supply to the lighting devices can also be made by the lighting devices themselves e.g. by connecting one lighting device to the next lighting device by a connector.

The object is also achieved by a mounting system that includes a plurality of such mounts.

The invention is explained in greater diagrammatic detail in the following figures using exemplary embodiments. For greater clarity, elements that are identical or have the same effect may be given the same reference sign.

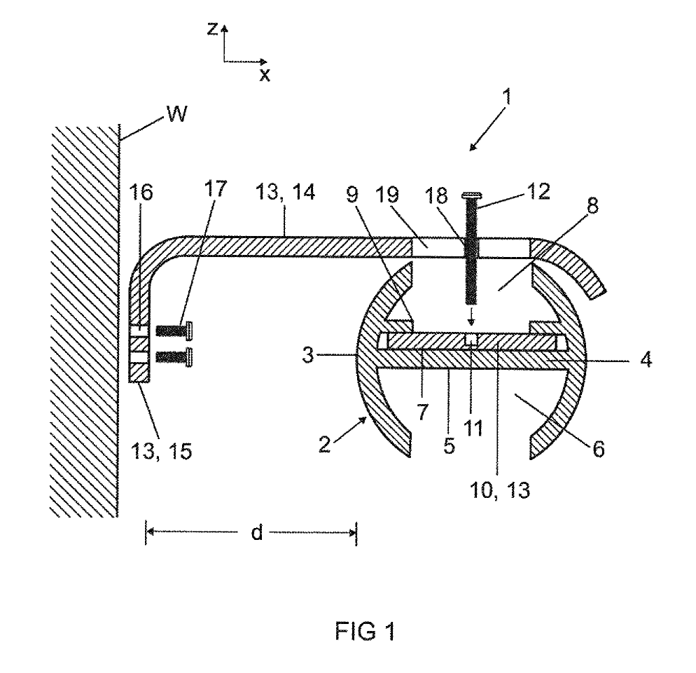

FIG. 1 shows a cross-sectional diagram of a mount viewed from the front according to a first embodiment;

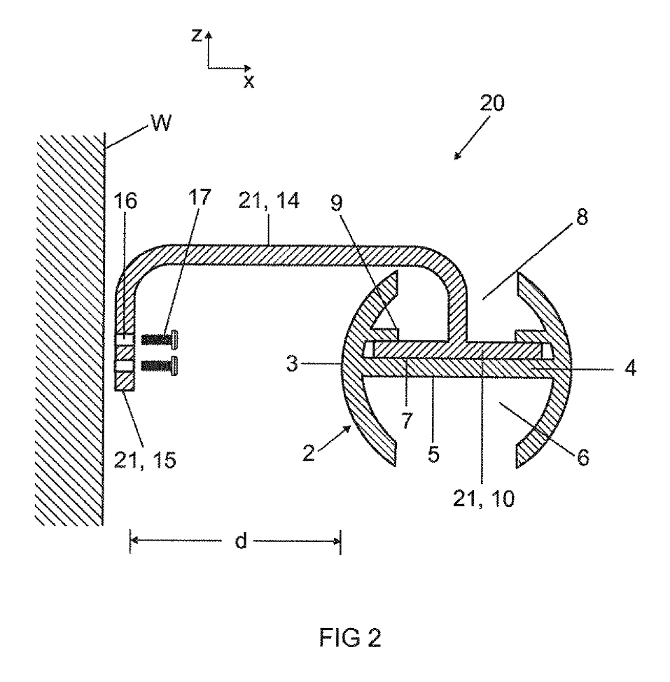

FIG. 2 shows a cross-sectional diagram of a mount viewed from the front according to a second embodiment;

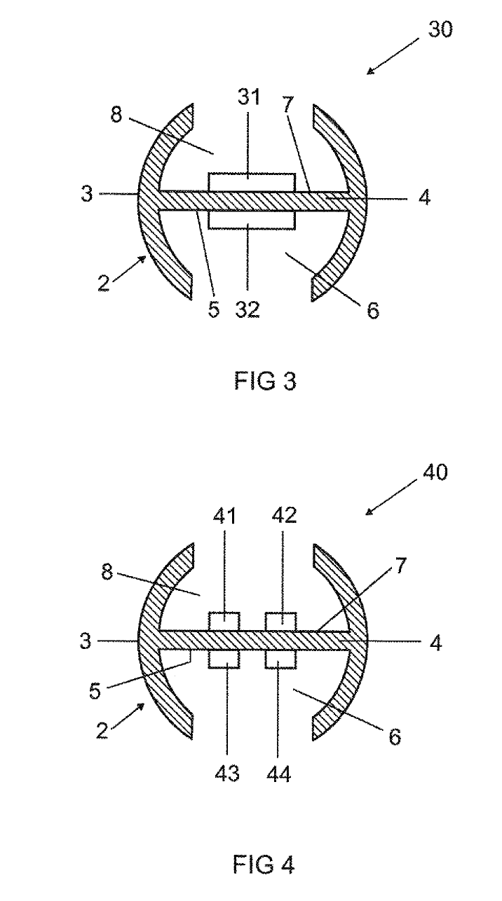

FIG. 3 shows a cross-sectional diagram of a mounting rail, fitted with components, of a mount viewed from the front according to a third embodiment;

FIG. 4 shows a cross-sectional diagram of a mounting rail, fitted with components, of a mount viewed from the front according to a fourth embodiment;

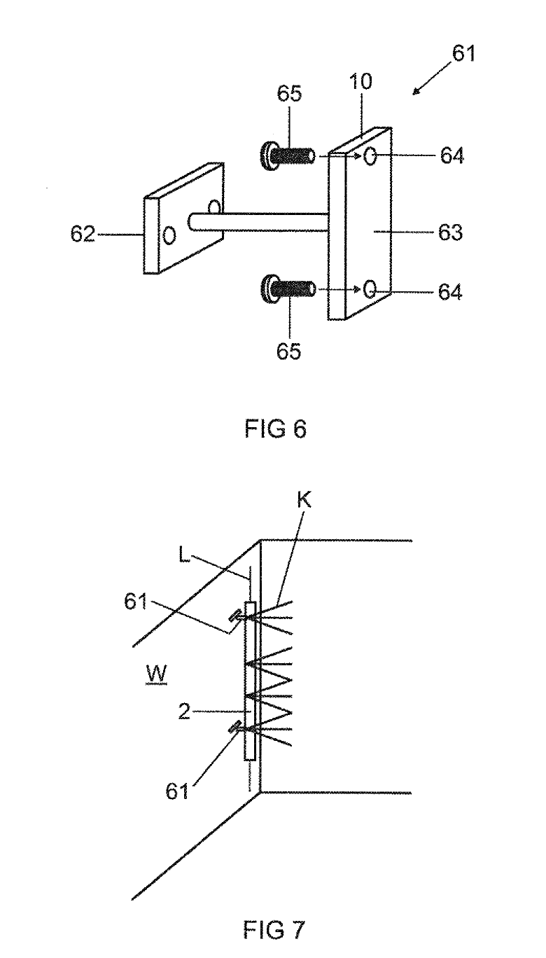

FIG. 6 shows a stand-off bracket of a mount viewed from an angle according to a sixth embodiment;

FIG. 7 shows a sketch of a mount according to the sixth embodiment fixed to a wall.

FIG. 1 shows a cross-sectional diagram of a mount 1 viewed from the front according to a first embodiment having an elongated mounting rail 2, which in this view extends along a longitudinal axis lying perpendicular to the image plane. The mounting rail 2 has a substantially H-shaped cross-section, wherein the arms 3 that are upright here are curved towards each other in an oval shape. A straight, horizontal cross-piece 4 connecting the arms 3 adjoins the arms 3 in the center and forms with said arms a partially curved “H”.

A first installation chamber 6, open at the bottom, for accommodating a view screening element (not shown), in particular a drape, is formed from a first, bottom side 5 of the cross-piece 4 and the sections of the arms 3 of the “H” adjoining thereto. For example, running elements of a drape can be inserted in a longitudinal direction in the first installation chamber 6. The first installation chamber 6, however, is fundamentally not restricted to a specific application, but can also accommodate at least one lighting device for example.

Similarly, a second, top side 7 of the cross-piece 4 and the sections of the arms 3 adjoining thereto form a second, top installation chamber 8 that is oriented such that it is open at the top in this case. The arms 3 of the mounting rail 2 each have in the region of the second installation chamber 8 a ledge 9 pointing into the second installation chamber 8, said ledge being arranged parallel to and separated from the cross-piece 4. A mounting plate 10 having a central threaded hole 11 for receiving a screw 12 can thereby be inserted in a gap between the cross-piece 4 and the ledges 9. The mounting plate 10, as a part of a fixing element designed as a stand-off bracket 13, is dimensioned such that it has a length that is only short compared with the length of the mounting rail 2. The mounting plate 10 is used to fix the mounting rail 2 to a wall W, for which purpose a plurality of mounting plates 10 are inserted in the mounting rail 2, spaced apart from one another, along the entire length of the mounting rail 2. In each gap between the mounting plates 10, a lighting device (not shown), for instance a rigid or flexible LED strip, can be mounted on the second, top side 7. The mounting rail 2 can thereby be equipped in a multipurpose manner with here two functionalities, namely one functionality as a batten for a view screening element e.g. as a curtain rail, and simultaneously as a wallwasher, in the orientation shown here e.g. as an uplighter.

This multipurpose design means that it is possible to dispense with procuring and fitting two separate devices (wallwasher and curtain rail), which is not only cheaper but also has an advantageous effect in terms of design. The side sections 3 adjoining the second, top installation chamber 8 can be used in the mounting orientation shown here to prevent the eye looking directly onto the lighting strip and thereby being dazzled, to obstruct a view of the lighting strip and the mounting plate 10 for aesthetic reasons, to prevent the lighting strip being touched and to provide an optical screen to produce a defined light/dark boundary.

The mounting rail 2 is fixed to the wall W by means of fixing elements in the form of a plurality of stand-off brackets 13, said stand-off bracket being right-angled in shape and having on a first section 14 a narrow through-hole 18 for the passage of the screw 12, said screw 12 being intended to be screwed into the threaded hole 11 of the mounting plate 10. The first section 14 is thereby pressed onto the mounting rail 2 in the region of the mounting plate 10 and joined compressively to said mounting rail. On a second section 15 of the stand-off bracket 13, which is bent at right-angles to the first section 14, are located through-holes 16 for fixing to the wall W, for example by means of respective screws 17.

As an alternative to the narrow through-hole 18, the first section 14 of the stand-off bracket 13 can also include, for example, a slot 19 that extends at least over part of the length (along an x-axis) of the first section 14, so that a distance d between the mounting rail 2 and the second section 15, or the wall W, can be adjusted easily via corresponding positioning of the mounting rail 2 along the slot 19. This enables a user-friendly, customized installation.

The mounting rail 2 is made of aluminum for straightforward and effective cooling of the lighting device. The mounting rail 2 can also have for this purpose cooling protrusions (cooling fins, cooling pins, etc.) and/or in particular vertical holes acting as cooling slots (not shown). This serves to improve thermal management.

FIG. 2 shows in a view similar to FIG. 1 a mount 20 according to a second embodiment, which in contrast to the mount 1 of the first embodiment has a single-piece stand-off bracket 21, which can be inserted through an open end of the mounting rail 2. The stand-off bracket 21 is easier to manufacture compared with the multi-piece stand-off bracket 10, 12, 13 of FIG. 1 and does not require maintenance, although the mounting rail 2 can only be fixed to the wall W at a fixed distance d.

FIG. 3 shows the mounting rail 2 of a mount 30 according to a third embodiment in a cross-section away from the mounting plate. Unlike the functionalities shown in FIG. 1 and FIG. 2, the mount now has two lighting functionalities. For this purpose are arranged both a lighting strip 31 on the first, top side 7 of the cross-piece 4 of the mounting rail 2 and a further lighting strip 32 on the second, bottom side 5. For example, the lighting strip 32 directed downwards can be used for room illumination, while the lighting strip 31 directed upwards can be used for ceiling illumination, or uplighting, as a “wallwasher”. Of course the orientation of the mounting rail is not restricted to “upwards/downwards” but can also be, for example, towards two sides, wherein then one of the installation chambers 6 or 8 can open, for example, towards a side wall, while the respective other recess 8 or 6 opens into a room. The second lighting strip 32 can, for example, provide light having a different color from the first lighting strip 31. For instance, the second lighting strip 32 can include light sources having a white emission, while the first lighting strip 31 can include light sources providing monochromatic light e.g. for decorative lighting.

FIG. 4 shows the mounting rail 2 of a mount 40 according to a fourth embodiment in a view similar to FIG. 3, although in this case two lighting strips are arranged in each case on the second, top side 7 and on the first, bottom side 5 of the cross-piece 4. For instance, a first lighting strip 41 mounted on the second side 7 can have a white emission and a second lighting strip 42 mounted on the second side 7 can have a color emission. Similarly, a first lighting strip 43 mounted on the bottom side 4 can have a white emission and a second lighting strip 44 mounted on the bottom side 4 can have a color emission. This achieves a particularly versatile emission characteristic, for instance by it being possible for the lighting strips 41 to 44 to be switched on and/or dimmed individually, so that for both sides it is possible to choose between colored decorative lighting and white functional lighting.

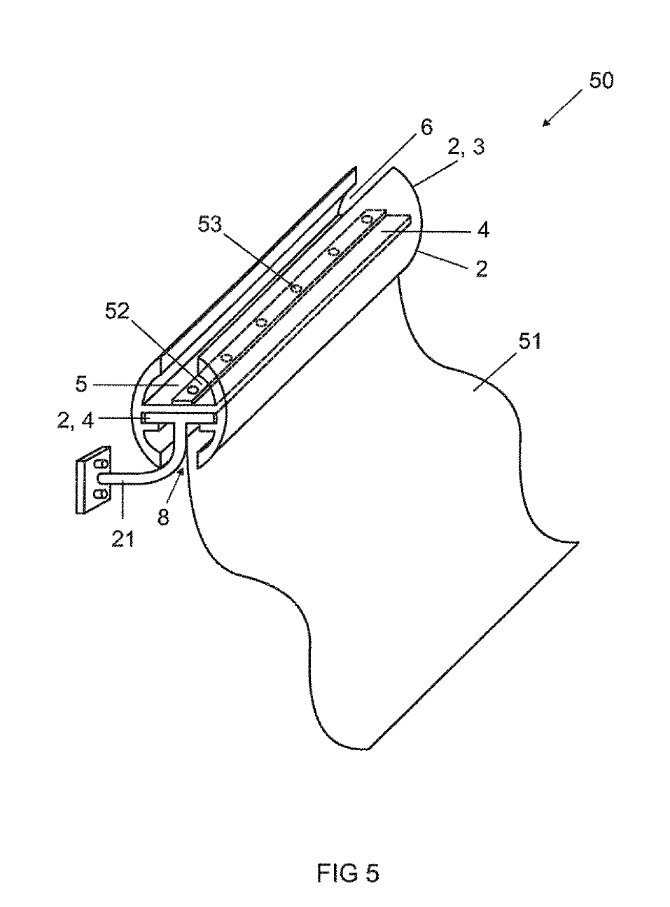

FIG. 5 shows a mount 50 viewed at an angle according to a fifth embodiment including the mounting rail 2 and a stand-off bracket 21, said stand-off bracket 21 being identical in function to the stand-off bracket 21 of FIG. 2. Unlike the embodiment shown in FIG. 2, however, the mounting rail 2 is now rotated through 180° about its longitudinal axis, so that the first installation chamber 6 opens in an upwards direction, while the second installation chamber 8 is directed downwards. In this case, for example, a view screening element, shown here in the form of a drape 51, can be inserted in the second installation chamber 8 and then fixed or restricted at each end by the stand-off bracket 21 to prevent it sliding out. In this case, the first surface 5 can be fitted over the entire length with a lighting strip 52, the lighting strip 52 here including vertically-emitting light emitting diodes 53 that are spaced regularly on the surface thereof.

The installation chamber 6 and/or the installation chamber 8 can be covered at least partially by at least one optical element (not shown). This cover can include, for example, at least one lens, a diffuser, a reflector (with or without pivot facility), one color screen and/or one aperture.

FIG. 6 shows a stand-off bracket 61 of a mount according to a sixth embodiment, said stand-off bracket not having a right-angled design but designed so that its two fixing surfaces 62 and 63 are arranged in a straight line. A mounting rail, for example like the mounting rail 2 in FIGS. 1 to 5, can thereby be mounted having an installation chamber 6 or 8 opening towards a wall W and an installation chamber 8 or 6 opening into the room. The mounting plate 10 of the stand-off bracket 61 has the same function here as that in FIGS. 1 to 5.

The mounting plate 10, by virtue of the embodiment that is shown here containing two through-holes 64, can also be used as a mechanical connecting element between two mounting rails 2. The mounting rails can thereby be connected together easily without a gap. Screws 65 can be inserted through each of the through-holes 64 and subsequently screwed to a mounting rail. The mounting rail can have suitable screw holes for the purpose.

FIG. 7 shows a sketch of a possible fixing arrangement of a mounting rail 2 by means of the stand-off brackets 61 of FIG. 6. For instance, the mounting rail 2 can be arranged on the wall W so that its longitudinal axis L is vertical and in such a way that an installation chamber fitted with a lighting device opens into the room to be illuminated and light is radiated thereinto as indicated by the light cones K. A second installation chamber opening in the opposite direction can, for example, in turn include a lighting function (not shown here) in the form of a wallwasher.

Alternatively it is possible to implement, for example, a ceiling installation having a wallwashing effect downwards or an installation having a horizontal light emission.

Of course the present invention is not restricted to the exemplary embodiments shown. For instance, features of the various exemplary embodiments can also be used as an alternative or jointly.

For example, instead of a mounting rail having an H-shaped cross-section, a mounting rail having a recumbent T-shaped cross-section can be used. A recumbent T-shaped cross-section of this type can be achieved, for example, by one of the arms of the H in FIG. 1 being left off, either entirely or for only one installation chamber. Thus the lighting function may then also be used as a side-wallwasher, in addition to a drape holder.

In addition, the fixing element does not need to be a stand-off bracket. Instead, a mounting rail can also be fixed directly to a wall, a piece of furniture, etc.

Even more functions can be associated with the mount, such as for example a music playback function, a sensor function and/or a data communications function e.g. in the form of a WLAN router.

### LIST OF REFERENCES

1 mount
2 mounting rail
3 side section
4 cross-piece
5 first side of the cross-piece
6 first installation chamber
7 second side of the cross-piece
8 second installation chamber
9 ledge
10 mounting plate
11 threaded hole
12 screw
13 stand-off bracket
14 first section of the stand-off bracket
15 second section of the stand-off bracket
16 through-hole
17 screw
18 through-hole
19 slot
20 mount
21 stand-off bracket
30 mount
31 first lighting strip
32 second lighting strip
40 mount
41 lighting strip
42 lighting strip
43 lighting strip
44 lighting strip
50 mount
51 drape
52 lighting strip
61 stand-off bracket
62 mounting surface
63 mounting surface
64 through-hole
65 screw
W wall
L light cone

1. A mount, comprising:
an elongated basic form which is configured to comprise at least two functionalities, of which at least one functionality is a lighting functionality,
wherein to implement the at least one lighting functionality, the mount comprises at least one semiconductor lighting device.

2. The mount according to claim 1,
wherein one of the at least two functionalities is a fastening function for view screening elements.

3. The mount according to claim 1, further comprising:
at least one mounting surface for the at least one lighting device, wherein the mounting surface has a protruding wall at least on one side.

4. The mount according to claim 1, further comprising:
a mounting rail.

5. The mount according to claim 4,
wherein the mounting rail has a substantially H-shaped or recumbent T-shaped cross-section.

6. The mount according to claim 1,
wherein the mount has at least two lighting functionalities,
wherein at least one respective semiconductor lighting device is present for each of the lighting functionalities.

7. The mount according to claim 1
wherein at least one of the semiconductor lighting devices has a lighting strip.

8. The mount according to claim 1
wherein the mount has two lighting functionalities and further comprises at least one lighting strip per lighting functionality,
wherein the at least one lighting strip of one of the lighting functionalities has a different emission characteristic from the at least one lighting strip of the other lighting functionality.

9. The mount according to claim 7,
wherein at least one lighting strip is covered at least partially by an optical element.

10. The mount according to claim 1,
which is configured as a heat sink for at least the at least one lighting functionality.

11. The mount according to claim 1, further comprising at least one fixing element, configured to fix the mount.

12. The mount according to claim 17,
wherein the stand-off bracket is configured to variable adjustment of the stand-off distance.

13. The mount according to claim 11, wherein the fixing element is configured to electrically connect at least the at least one semiconductor lighting device.

14. A mounting system comprising a plurality of mounts, each mount comprising:
an elongated basic form which is configured to comprise at least two functionalities, of which at least one functionality is a lighting functionality, wherein to implement the at least one lighting functionality, the mount comprises at least one semiconductor lighting device.

15. The mount according to claim 1,
wherein the at least one semiconductor lighting device comprises at least one LED lighting device.

16. The mount according to claim 2,
wherein the view screening elements comprise drapes.

17. The mount according to claim 11,
wherein the at least one fixing element comprises a stand-off bracket.
